(19) United States
(12) Patent Application Publication
(10) Pub. No.: US 2024/0294694 A1
(43) Pub. Date: Sep. 5, 2024

(54) POLYURETHANE COMPOSITIONS, COMPOSITE MATERIALS PREPARED WITH THE SAME AND PREPARATION METHODS THEREOF

(71) Applicant: Dow Global Technologies LLC, Midland, MI (US)

(72) Inventors: Fang Du, Dortmund (DE); Luigi Pellacani, Carpi (IT); Kunpeng Guo, Shanghai (CN); Shaoguang Feng, Shanghai (CN); Gang Sun, Shanghai (CN); Jianqing Jiao, Shanghai (CN)

(21) Appl. No.: 18/572,384

(22) PCT Filed: Sep. 12, 2021
(86) PCT No.: PCT/CN2021/117930

§ 371 Date: Dec. 20, 2023

(51) Int. Cl. C08G 18/10; C08G 18/32; C08G 18/34; C08G 18/76; C08J 5/04; C08K 7/02

(52) U.S. Cl. CPC C08G 18/10; C08G 18/3218; C08G 18/348; C08G 18/7671; C08J 5/04; C08K 7/02

(57) ABSTRACT

A polyurethane composition, a composite material prepared with same and a method of preparing a polyurethane resin using the polyurethane composition is provided. The polyurethane composition comprises A) an isocyanate component, comprising A1) and at least one of A2) and A3): A1) a first polyisocyanate compound: A2) a first prepolymer that is formed by reaction of a second polyisocyanate compound and a first polyol, wherein the first prepolymer has a NCO content of 21-25%: A3) a second prepolymer that is formed by reaction of a third polyisocyanate compound and a second polyol, wherein the second prepolymer has a NCO content of 10-20%; wherein the total amount of the first prepolymer and the second prepolymer is 10-70 wt % based on the total weight of the isocyanate component: B) an isocyanate-reactive component. comprising a third polyol and an isocyanate reactive (meth) acrylate monomer; and C) a free radical initiator.

### FIELD OF THE INVENTION

The present disclosure relates to a polyurethane composition, a composite material comprising a fiber reinforcement material and a polyurethane resin obtained from the polyurethane composition, and a method for preparing the polyurethane composition. The polyurethane resin has a tunable viscosity, long open time, and good physical mechanical properties, which make it suitable for a broad range of composite manufacturing processes and end applications.

### BACKGROUND TECHNOLOGY

Composite materials are a type of heterogeneous materials, comprising fiber reinforcement materials to provide high strength and a polymer matrix to fix and protect the fibers from damage. The performance and service life of a composite material not only depend on the reinforcement materials, but also highly depend on the quality of impregnation and the properties of the polymer resin utilized. It typically requires the liquid polymer resin to have a low viscosity and long open time to ensure good impregnation quality, while providing a cure time to allow for adequate production cycle time. Apart from that, physical mechanical properties of the cured resin such as tensile/flexural strength and modulus are also important to provide a longer lifespan for end products

Typical customer Critical to Quality (CTQs) measures depend on the production process and end-application of the final composite material.

In the vacuum infusion process for the wind blade application, long open time (up to hours) with tunability and low initial resin viscosity (<150 mPa·s for good quality of infusion) are desired. According to the Germanischer Lloyd standard (Rules for Classification and Construction II Materials and Welding, 2: Non-metallic Materials), the cured polymer for wind blade infusion must also meet various additional requirements, e.g. flexural strength >100 MPa (ISO 178), Fractural strain %>2.5% (ISO 178), Heat distortion temperature (HDT)>70° C. (ISO 75-2, mode A).

Epoxy resins are currently the dominating resin technology in the wind blade infusion market. This is due to the ease of processing (long open-time with high tunability in the range 1-10 hours) and good polymer physical property performance. However, due to the high cost and slow curing profile, there is a market need for better performing alternative solutions

Conventional polyurethane resins typically consist of 2 components, an isocyanate and a formulated polyol. They represent a class of cost-efficient alternatives to epoxy resins, leading to polymer properties characterized by high toughness, hardness, good abrasion and fatigue resistance. However, the intrinsically fast reactivity of conventional two-component polyurethane solutions, while leading to advantageously fast curing profile, also lead to open time values that are too short for certain applications. For this reason, two-component polyurethane solutions are undesirable for composite applications requiring long open times, such as vacuum infusion.

For the above reasons, there is still an unanswered need in the polyurethane manufacture industry to develop a polyurethane composition having a low viscosity, long open time, fast curing profile, and good physical mechanical properties after cure. After persistent exploration, the inventors have surprisingly developed a polyurethane composition which provides low initial viscosity, long open time, high tunability of the reaction profile, and satisfying physical mechanical and thermal properties after cure.

### SUMMARY OF THE INVENTION

The present disclosure provides a unique polyurethane composition, especially for composite applications, a composite material comprising a fiber reinforcement material and a polyurethane resin obtained from the polyurethane composition, and a method for preparing the polyurethane composition.

In a first aspect of the present disclosure, the present disclosure provides a polyurethane composition comprising
A) an isocyanate component comprising A1) and at least one of A2) or A3):
   A1) a first polyisocyanate compound;
      A2) a first prepolymer that is formed by reaction of a second polyisocyanate compound and a first polyol, wherein the first polyol has an average equivalent weight of from 30 to 200 g/eq and an average functionality of 2-3 and the first prepolymer has a NCO content of 21-25% based on the weight of the first prepolymer;
   A3) a second prepolymer that is formed by reaction of a third polyisocyanate compound and a second polyol, wherein the second polyol has an average equivalent weight of from 250 to 3000 g/eq and an average functionality of 2-3 and the second prepolymer has a NCO content of 10-20% based on the weight of the second prepolymer;
      wherein the total amount of the first prepolymer A2) and the second prepolymer A3) is 10-70 wt %, based on the total weight of the isocyanate component A);
B) an isocyanate-reactive component comprising
   B1) a third polyol; and
   B2) an isocyanate reactive (meth)acrylate monomer; and
C) a free radical initiator.

The polyurethane composition may further comprise other additives. The additives can be selected from the group consisting of catalysts for the reaction between the isocyanate group and the hydroxyl group, radical polymerization accelerators, defoamers, pigments, fillers, and moisture scavengers.

In one preferred embodiment, the first prepolymer A2) and the second prepolymer A3) are used individually or in combination in any ratio, and the total weight of the first prepolymer A2) and the second prepolymer A3) is less than 45 wt % based on the total weight of the isocyanate component A).

In another preferred embodiment, the total weight of the first prepolymer A2) and the second prepolymer A3) is from 45 wt % to 70 wt % based on the total weight of the isocyanate component A), and the weight ratio of the first prepolymer A2) and the second prepolymer A3) is from 5:1 to 1:5.

In a second aspect of the present disclosure, the present disclosure provides a composite material comprising a fiber reinforcement material and a polyurethane resin obtained from the polyurethane composition described herein.

In a third aspect of the present disclosure, the present disclosure provides a method of preparing a polyurethane resin comprising:
1) providing A) an isocyanate component, comprising A1) and at least one of A2) and A3):
   A1) a first polyisocyanate compound;
   A2) a first prepolymer that is formed by reaction of a second polyisocyanate compound and a first polyol, wherein the first polyol has an average equivalent weight of from 30 to 200 g/eq and an average functionality of 2-3 and the first prepolymer has a NCO content of 21-25 wt %;
   A3) a second prepolymer that is formed by reaction of a third polyisocyanate compound and a second polyol, wherein the second polyol has an average equivalent weight of from 250 to 3000 g/eq and an average functionality of 2-3 and the second prepolymer has a NCO content of 10-20 wt %;
      wherein the total amount of the first prepolymer A2) and the second prepolymer A3) is 10-70 wt %, based on the total weight of the A) isocyanate component;
2) providing an isocyanate-reactive component B), comprising
   B1) a third polyol including polyether, polyester, and polycarbonate polyols, has an average equivalent weight of from 80 to 600 g/eq and an average functionality of 2-5; and
   B2) an isocyanate reactive (meth)acrylate monomer; and
3) providing a free radical initiator C); and
4) then reacting the isocyanate component A) with the isocyanate-reactive component B) in the presence of the free radical initiator C) to form the polyurethane composition described herein.

It is to be understood that both the foregoing general description and the following detailed description are exemplary and explanatory only and are not restrictive of the invention, as claimed.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

### Definitions

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.)

Unless stated to the contrary, implicit from the context, or customary in the art, all parts and percents are based on weight and all test methods are current as of the filing date of this disclosure.

The term “composition” refers to a mixture of materials which comprise the composition, as well as reaction products and decomposition products formed from the materials of the composition

The terms “comprising,” “including,” “having,” and their derivatives, are not intended to exclude the presence of any additional component, step or procedure, whether or not the same is specifically disclosed. To avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “isocyanate” is a chemical that contains at least one isocyanate group in its structure. An isocyanate group is represented by the formula:—N═C═O. An isocyanate that contains more than one, or at least two, isocyanate groups is a “polyisocyanate.” An isocyanate that has two isocyanate groups is a di-isocyanate and an isocyanate that has three isocyanate groups is a tri-isocyanate, etc. An isocyanate may be aromatic or aliphatic.

A “polyol” is an organic compound containing multiple hydroxyl (—OH) groups. In other words, a polyol contains at least two hydroxyl groups. Non-limiting examples suitable polyols include diols (which contain two hydroxyl groups), triols (which contain three hydroxyl groups), and multi-hydroxyl containing polyols. Polyether polyols may include also a small amount of mono functional species (monols), namely species carrying only one hydroxyl group, as formed during the synthesis of the polyol as part of side reactions forming unsaturated species, namely species carrying double bonds.

A “polyether” is a compound containing two or more ether linkages in the same linear chain of atoms.

A “polyester” is a compound containing two or more ester linkages in the same linear chain of atoms.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer” (which is used interchangeably with the term “copolymer”) includes bipolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

“Hydroxyl number” represents the content of hydroxyl group in a polyol. The methods for measuring hydroxyl number are well known to those skilled in the art and are disclosed by, for example, Houben Weyl, Methoden der Organischen Chemie, vol. XIV/2 Makromolekulare Stoffe, p. 17, Georg Thieme Verlag, Stuttgart 1963.

“Average equivalent weight” is the average of the equivalent weight associated with the various ingredients in a mixture. When the mixture is formed by different polyols, the average equivalent weight may be calculated as follows: measure the average OH number of the mixture using one of the various experimental techniques well known in the art, such as titration or near infrared spectroscopy, as OHav: then calculate the average equivalent weight as

EWav=56100/OHav.

“Average functionality” is the average of the functionality associated with the various ingredients in a mixture. When the mixture is formed by different polyols, the average functionality may be calculated as follows: given the average OH number of the mixture (O)Hav), given the functionality of the first component (f1), given the functionality of the second component (f2), given the OH number of the first component (OH1), given the OH number of the second component (OH2), given the fractional weight of first component (a), and given the fractional weight of second component (b=1-a), the average functionality of the mixture is

$$Functionality av . = ( OHav \times f 1 \times f 2 ) / [ ( OH 1 \times f 2 \times a ) + ( OH 2 \times f 1 \times b ) ]$$

The First Polyisocyanate Compound A1

According to various embodiments of the present disclosure, the first polyisocyanate compound A1 used for the component A is an aromatic compound having at least two isocyanate groups. According to a preferable embodiment of the present disclosure, the polyisocyanate compound comprises at least one aromatic ring (e.g. aryl group or heteroaryl group) and all the isocyanate groups in the polyisocyanate compound are directly attached to the aromatic rings without the existence of any interlink group therebetween. Carbodiimide modified derivatives of the above stated aromatic polyisocyanates may also be used for polyisocyanate compound A1, wherein the term carbodiimide modified derivatives may comprise carbodiimide modified aromatic polyisocyanates comprising at least two isocyanate groups. In another preferable embodiment, suitable aromatic polyisocyanate compounds include m-phenylene diisocyanate, 2,4-toluene diisocyanate and/or 2,6-toluene diisocyanate (TDI), the various isomers of diphenylmethanediisocyanate (MDI), the various oligomers of MDI that are present in polymeric MDI (polyphenylmethane polyisocyanate), carbodiimide modified MDI products, or mixtures thereof. In another preferable embodiment, suitable aromatic polyisocyanate include of compounds the various isomers diphenylmethanediisocyanate (MDI), and carbodiimide modified MDI products. In another preferable embodiment, suitable aromatic polyisocyanate compounds include the various isomers of diphenylmethanediisocyanate (MDI) in monomeric form, polymeric form or a combination thereof.

Generally, the amount of the first polyisocyanate compound A1 may vary based on the actual requirement of the polyurethane product. For example, as one illustrative embodiment, the content of the first polyisocyanate A1 compound can be from 15 wt % to 70 wt %, 15 wt % to 60 wt %, or from 18 wt % to 50 wt %, or from 23 wt % to 40 wt %, or from 25 wt % to 37 wt %, based on the total weight of the polyurethane composition.

In another preferable embodiment, the content of the first polyisocyanate compound A1 can be from 30 wt % to 95 wt %, or from 30 wt % to 90 wt %, or from 35 wt % to 90 wt %, or from 40 wt % to 85 wt %, or from 45 wt % to 80 wt %, or 50 wt % to 70 wt %, based on the total weight of the isocyanate component A.

The First Prepolymer A2

The first prepolymer A2, is formed by reaction of a first polyol with a second polyisocyanate compound. The second polyisocyanate compound can be monomeric isocyanate or polymeric isocyanate, wherein the monomeric isocyanate refers to an isocyanate molecule that in any case carries 2 NCO groups, such as MDI or TDI. The second polyisocyanate compound used for forming the prepolymer A2 is an aromatic compound having at least two isocyanate groups: it may be described in similar manner as the component A1 was previously described.

The first polyol component used in the prepolymer A2, has an average equivalent weight of from 30 to 200 g/eq and an average functionality of 2-3. In one preferable embodiment of the present application, the polyol is selected from the group consisting of ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl) -cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, tripropylene glycol, dibutylene glycol, tributylene glycols, trimethylolpropane, glycerol, pentaerythritol, and sugar compounds such as, for example, glucose, sorbitol, mannitol and sucrose, polyhydric phenols, resols and any combination thereof. In another preferable embodiment the polyol is a polyether polyol, which can be prepared by reacting an olefin oxide with a starter in the presence of a catalyst. The catalyst is preferably but not limited to an alkaline hydroxide, an alkaline alkoxide, antimony pentachloride, boron trifluoride-diethyl etherate or a combination thereof. Suitable polymerization catalysts may include potassium hydroxide, cesium hydroxide, boron trifluoride, or a double cyanide complex (DMC) catalyst such as zinc hexacyanocobaltate or quaternary phosphazenium compound. The olefin oxide is preferably but not limited to tetrahydrofuran, ethylene oxide, propylene oxide, 1,2-butylene oxide, 2,3-butylene oxide, styrene oxide, or a combination thereof; preferably ethylene oxide and/or propylene oxide. The starter molecule is one of the ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, tripropylene glycol, dibutylene glycol, tributylene glycols, trimethylolpropane, glycerol, pentaerythritol, and sugar compounds such as, for example, glucose, sorbitol, mannitol and sucrose, polyhydric phenols, resols and any combination thereof

The content of the first polyol in prepolymer A2 can be adjusted by the skilled in the art as long as the resulting prepolymer A2 has a NCO content of from 21 wt % to 25 wt %, preferably a NCO content of from 22 wt % to 24 wt %, based on the total weight of the first prepolymer

Prepolymer A2 has a NCO content of from 21 wt % to 25 wt %, preferably a NCO content of from 22 wt % to 24 wt %, based on the total weight of the first prepolymer.

The Second Prepolymer A3

The second prepolymer A3, is formed by reaction of a second polyol with a third polyisocyanate. The third polyisocyanate compound used for forming the prepolymer A3 is an aromatic compound having at least two isocyanate groups: it may be described in similar manner as the component A1 was previously described.

The second polyol component used in the prepolymer A3 is a polyether polyol which can be prepared by reacting an olefin oxide with a starter in the presence of a catalyst. The catalyst is preferably but not limited to an alkaline hydroxide, an alkaline alkoxide, antimony pentachloride, boron trifluoride-diethyl etherate or a combination thereof. Suitable polymerization catalysts may include potassium hydroxide, cesium hydroxide, boron trifluoride, or a double cyanide complex (DMC) catalyst such as zinc hexacyanocobaltate or quaternary phosphazenium compound. The olefin oxide is preferably but not limited to tetrahydrofuran, ethylene oxide, propylene oxide, 1,2-butylene oxide, 2,3-butylene oxide, styrene oxide, or a combination thereof, preferably ethylene oxide and/or propylene oxide. The starter molecules include compounds having at least 1, preferably from 2 to 8 hydroxyl groups, more preferably from 2 to 4 hydroxyl groups per molecule: they may include one or more primary amine groups in the molecule. Suitable starter molecules are for example selected from the group comprising ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, trimethylolpropane, glycerol, pentaerythritol, castor oil, sugar compounds such as, for example, glucose, sorbitol, mannitol and sucrose, polybydric phenols, resols, such as oligomeric condensation products of phenol and formaldehyde and Mannich condensates of phenols, formaldehyde and dialkanolamines, and also melamine. Starter molecules having 1 or more primary amine groups in the molecules may be selected for example from the group consisting of aniline, ethylenediamine, TDA (toluenediamine), MDA (methylenedianiline) and PMDA (polymeric MDA), more preferably from the group comprising TDA and PMDA, an most preferably TDA.

In one preferable embodiment of the present application, the second polyol component used in the prepolymer A3 comprises at least one polyether polyol, and has an average functionality of 2-3, and an equivalent weight 250 to 3,000 g/eq, more preferably 500 to 2,500 g/eq, even more preferably 1,000 to 2,000 g/eq.

The content of the second polyol component used in the prepolymer A3 is from 20 wt % to 70 wt %, preferably 35 wt % to 70 wt %, more preferably 40 wt % to 60 wt % based on the total weight of prepolymer A3.

Prepolymer A3 has a NCO content of from 10 wt % to 20 wt %, or from 12 wt % to 19 wt %, or from 13 wt % to 18 wt %, or from 14 wt % to 16 wt %.

Prepolymer A2 may be referred to as the first prepolymer, and prepolymer A3 may be referred to as the second prepolymer. The total weight of the first prepolymer and the second prepolymer is from 10 wt % to 70 wt %, or from 10 wt % to 65 wt %, or from 15 wt % to 60 wt %, or from 20 wt % to 55 wt %, or from 30 wt % to 50 wt %, based on the total weight of the isocyanate component A.

The first prepolymer A2 and the second prepolymer A3 can be used individually or in combination in any ratio, when the total weight of the first prepolymer A2 and the second prepolymer A3 is less than 45 wt %, preferably less than 40%, preferably from 10 to 40 wt %, more preferably from 10 to 39 wt %, even more preferably from 12 to 38 wt %, or from 25 to 37 wt %, based on the total weight of the isocyanate component A; when the total weight of the first prepolymer A2 and the second prepolymer A3 is from 45 wt % to 70 wt % based on the total weight of the isocyanate component A, the weight ratio of the first prepolymer A2 and the second prepolymer A3 is from 5:1 to 1:5, preferably from 4:1 to 1:4, or from 4:1 to 1:2 or from 4:1 to 1.4:1

B1) the Third Polyol

The first polyol is the one used in the synthesis of prepolymer A2. The second polyol is the one used in the synthesis of prepolymer A3. The third polyol B1 is part of the isocyanate-reactive component B) of the polyurethane composition of the invention. The third polyol B1 bas an average equivalent weight of from 80 to 600 g/eq and an average functionality of 2-5. It includes the polyols commonly used to prepare polyurethane in the art, including but not limited to polyether polyols, polycarbonate polyols, polyester polyols, or combinations thereof.

The polyether polyol may be prepared by a known process, for example, by reacting an olefin oxide with a starter in the presence of a catalyst. The catalyst is preferably but not limited to an alkaline hydroxide, an alkaline alkoxide, antimony pentachloride, boron trifluoride-diethyl etherate or a combination thereof. The olefin oxide is preferably but not limited to tetrahydrofuran, ethylene oxide, propylene oxide, 1,2-butylene oxide, 2,3-butylene oxide, styrene oxide, or a combination thereof; preferably ethylene oxide and/or propylene oxide. Suitable starter molecules are for example selected from the group comprising ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine. Starter molecules having 1 or more primary amine groups in the molecules may be selected for example from the group consisting of aniline, ethylenediamine, TDA (toluenediamine), MDA (methylenedianiline) and PMDA (polymeric MDA), more preferably from the group comprising TDA and PMDA, an most preferably TDA.

The polyester polyol is prepared by reaction between a dibasic carboxylic acid or a dibasic carboxylic anhydride and a polyol. The dibasic carboxylic acid is preferably but not limited to an aliphatic carboxylic acid having 2-12 carbons, preferably but not limited to succinic acid, malonic acid, glutaric acid, adipic acid, suberic acid, azelaic acid, sebacic acid, dodecanoic acid, maleic acid, fumaric acid, phthalic acid, isophthalic acid, terephthalic acid, or a combination thereof. The dibasic carboxylic anhydride is preferably but not limited to phthalic anhydride, tetrachlorophthalic anhydride, maleic anhydride or a combination thereof. The polyol that reacts with the dibasic carboxylic acid or anhydride is preferably but not limited to ethylene glycol, diethylene glycol, 1,2-propanediol, 1,3-propanediol, dipropylene glycol, 1,3-methylpropanediol, 1,4-butanediol, 1,5-pentanediol, 1,6-hexanediol, neopentyl glycol, 1,10-decanediol, glycerine, trimethylolpropane, or a combination thereof. The polyester polyol also includes a polyester polyol prepared from a lactone. The polyester polyol prepared from a lactone is preferably but not limited to 8-caprolactone.

The polycarbonate polyol may be prepared by addition of carbon dioxide and an alkylene oxide compound to a starter comprising active hydrogen in the presence of a double metal cyanide catalyst. Also suitable for the purpose of the invention, are polycarbonate diols prepared by reacting a diol with a dihydrocarbyl carbonate or a diaryl carbonate or phosgene. The diol is preferably but not limited to 1,2-propanediol, 1,3-propanediol, 1,4-butanediol, 1,5-pentanediol, 1,6-hexanediol, diethylene glycol, trioxymethylene diol or a mixture thereof. The dihydrocarbyl or diaryl carbonate is preferably but not limited to diphenyl carbonate.

Generally, the amount of the third polyol may vary based on the actual requirement of the polyurethane product. For example, as one illustrative embodiment, the content of the third polyol can be from 5 wt % to 40 wt %, or from 6 wt % to 35 wt %, or from 7 wt % to 30 wt %, or from 8 wt % to 25 wt %, or from 10 wt % to 20 wt % based on the total weight of the polyurethane composition.

B2) the Isocyanate Reactive (Meth)Acrylate Monomer

The isocyanate reactive (meth)acrylate monomer B2 has at least one C═C bond and at least one isocyanate reactive group, such as OH. The isocyanate reactive (meth)acrylate monomer B2 can be selected from hydroxy C1-10 alkyl (meth)acrylate monomers, more preferably hydroxy C1-6 alkyl (meth)acrylate monomers, even more preferably hydroxypropyl (meth)acrylate monomer, hydroxyethyl (meth)acrylate, or hydroxybutyl (meth)acrylate monomer.

The term (meth)acrylate is meant to include both the corresponding acrylate as well as the methacrylate structure: thus, the term hydroxypropyl (meth)acrylate may correspond to hydroxypropylmethacrylate and/or to hydroxypropylacrylate.

Generally, the amount of the isocyanate reactive (meth)acrylate monomer may vary based on the actual requirement of the polyurethane product. For example, as one illustrative embodiment, the content of the isocyanate reactive (meth)acrylate monomer can be from 25 wt % to 40 wt %, or from 26 wt % to 38 wt %, or from 27 wt % to 37 wt %, or from 28 wt % to 35 wt %, based on the total weight of the polyurethane composition.

C) The Free Radical Initiator

The free radical initiator can be azo compound or peroxide. Preferably, the azo compound can be 2,2-azobisisobutyronitrile (AIBN); the peroxide can be selected from the group consisting of tert-butyl peroxybenzoate, butyl 4,4-di(tert-butylperoxy)valerate, di-tert-amyl peroxide, dicumyl peroxide, di(tert-butylperoxyisopropyl) benzene, 2,5-dimethyl-2,5-di(tert-butylperoxyl)hexane, tert-butyl cumyl peroxide, 2,5-dimethyl-2,5-di(tert-butylperoxyl)hexyne-3, di-tert-butyl peroxide, 3,6,9-triethyl-3,6,9-trimethyl-1,4,7-triperoxonane, isopropylcumyl hydroperoxide, 1,1,3,3-tetramethylbutyl hydroperoxide, cumyl hydroperoxide, tert-butyl hydroperoxide, and any combinations thereof.

In general, the content of the free radical initiator used herein is larger than zero, at least 0.1 wt %, or at least 0.2 wt %, or at least 0.3 wt % and is at most 6.0 wt %, preferably at most 5.0 wt %, more preferably at most 4.0 wt %, more preferably at most 3.0 wt % or at most 2.0 wt %, or at most 1.0 wt %, based on the total weight of the polyurethane composition.

D) Other Additives

The polyurethane composition further optionally comprises other additives. The additives can be selected from the group consisting of catalysts for the reaction between the isocyanate group and the hydroxyl group, radical polymerization accelerators, defoamers, pigments, fillers, and moisture scavengers.

The polyurethane composition of the present application may comprise one or more catalysts that can promote the reaction between the isocyanate group and the hydroxyl group. Without being limited to theory, the catalysts can include, for example, glycine salts; tertiary amines; tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, A1, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate, bismuth salts of organic carboxylic acids, e.g., bismuth octanoate; organometallic derivatives of trivalent and pentavalent As, Sb and Bi and metal carbonyls of iron and cobalt; titanium (IV) based catalysts such as such as tetraisopropyl titanate, tetra(n-butyl) titanate, tetraoctyl titanate, titanium acetic acid salts, titanium diisopropoxybis(acetylacetonate), and titanium diisopropoxybis (ethyl acetoacetate); zirconium-based catalysts such as zirconium tetraacetylacetonate, zirconium hexafluoroacetylacetonate, zirconium trifluoroacetylacetonate, tetrakis (ethyltrifluoroacetyl-acetonate) zirconium, tetrakis(2,2,6,6-tetramethyl-heptanedionate), zirconium dibutoxybis (ethylacetoacetate), and zirconium diisopropoxybis (2, 2, 6, 6-tetramethyl-heptanedionate); or mixtures thereof. According to a most preferable embodiment of the present disclosure, the catalyst for the reaction between the isocyanate component A) and the isocyanate-reactive component B), and the reaction between the first polyisocyanate and the first polyol or the reaction between the second polyisocyanate and the second polyol is a bismuth salts of organic carboxylic acids, e.g., bismuth (III) octanoate or bismuth (III) neodecanoate.

In general, the content of the catalyst used herein is larger than zero and is at most 2.0 wt %, preferably at most 1.5 wt %, more preferably at most 1.0 wt %, more preferably at most 0.5 wt % or at most 0.1 wt %, or at most 0.05 wt %, based on the total weight of the polyurethane composition.

The polyurethane composition of the present application may optionally comprise a radical polymerization accelerator. The accelerator can be selected from all types of metallic or amine accelerators. In general, the content of the accelerator used herein is larger than zero and is at most 2.0 wt %, preferably at most 1.5 wt %, more preferably at most 1.0 wt %, more preferably at most 0.5 wt % or at most 0.1 wt %, or at most 0.05 wt %, based on the total weight of the polyurethane composition.

The polyurethane composition of the present application may optionally comprise an inhibitor. The inhibitor can be commonly used inhibitors. In general, the content of the inhibitor used herein is larger than zero and is at most 2.0 wt %, preferably at most 1.5 wt %, more preferably at most 1.0 wt %, more preferably at most 0.5 wt % or at most 0.1 wt %, or at most 0.05 wt %, based on the total weight of the polyurethane composition.

The polyurethane composition of the present application may optionally comprise a defoamer. The defoamer can be silicone or organic defoamers. In general, the content of the defoamer used herein is larger than zero and is at most 2.0 wt %, preferably at most 1.5 wt %, more preferably at most 1.0 wt %, more preferably at most 0.8 wt %, or at most 0.5 wt % based on the total weight of the polyurethane composition.

The polyurethane composition of the present application may optionally comprise a moisture scavenger. The moisture scavenger can be commonly used zeolites or liquid water scavengers. In general, the content of the moisture scavenger used herein is larger than zero and is at most 10 wt %, preferably at most 8 wt %, more preferably at most 7 wt %, more preferably at most 6 wt % or at most S wt %, or at most 1 wt %, based on the total weight of the polyurethane composition.

According a preferable embodiment of the present disclosure, the polyurethane composition is substantially free of water or moisture intentionally added therein. For example, “free of water” or “water free” means that the mixture of all the raw materials used for preparing the polyurethane composition comprise less than 3% by weight, preferably less than 2% by weight, preferably less than 1% by weight, more preferably less than 0.5% by weight, more preferably less than 0.2% by weight, more preferably less than 0.1% by weight, more preferably less than 100 ppm by weight based on the total weight of the mixture of raw materials.

The polyurethane composition of the present invention may further comprise conventional additives such as, for example, light stabilizers, ultraviolet (UV) absorbing compounds, leveling agents, wetting agents, dispersants, neutralizers, or rheology modifiers, or mixtures thereof. These additives may be present in an amount of from zero to 20%, from 0.1 to 10%, by weight based on the weight of the polyurethane composition.

The polyurethane composition of the present invention may be prepared with techniques known in the art. The process of preparing the polyurethane composition typically comprises
1) providing a component A) an isocyanate component, comprising A1) and at least one of A2) and A3),
   A1) a first polyisocyanate compound;
   A2) a first prepolymer that is formed by reaction of a second polyisocyanate compound and a first polyol, wherein the first polyol has an average equivalent weight of from 30 to 200 g/eq and an average functionality of 2-3 and the first prepolymer has an NCO content of 21-25%;
   A3) a second prepolymer that is formed by reaction of a third polyisocyanate compound and a second polyol, wherein the second polyol has an average equivalent weight of from 250 to 3000 g/eq and a average functionality of 2-3 and the second prepolymer has a NCO content of 10-20%;
wherein the total amount of the first prepolymer A2) and the second prepolymer A3) is 10-70 wt %, based on the total weight of the A) isocyanate component,.
2) providing an isocyanate-reactive component B), comprising
   B1) a third polyol; and
   B2) an isocyanate reactive (meth)acrylate monomer; and
3) providing a free radical initiator C); and
4) providing optionally other additives D) as known in the art, such as catalysts for the reaction between the isocyanate group and the hydroxyl group, radical polymerization accelerators, defoamers, pigments, fillers and moisture scavengers.
5) then reacting the isocyanate component A) with the isocyanate-reactive component B) in the presence of the free radical initiator C) and optionally other additives D) to form the polyurethane composition described herein.

The polyurethane composition of the present invention may be prepared by a one-shot process. The polyurethane composition of the present invention may be prepared without the use of any reactive diluents such as styrene, methyl methacrylate.

The polyurethane composition can be cured at temperatures ranging from 4°° C. to 150° C., preferably ranging from ambient temperature (25° C.) to 80° C.

The polyurethane composition can be used in the preparation of a composite material. Thus, the composite material of the present application comprises a fiber reinforcement material and the polyurethane composition described herein. The fiber reinforcement material can be any fiber known in the art.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments, within the scope of the claims, will be apparent from consideration of the specification and/or practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto.

### Examples

The materials used in the examples are provided in Table 1 below.

TABLE 1
Raw materials used in the examples

| Ingredient | Description | Supplier |
|---|---|---|
| Polyol | PO (propylene oxide) based | Dow |
| | triol, functionality 3, EW = | |
| | 146 | |
| Hydroxypropyl | Hydroxy functionalized | Sigma |
| methacrylate | unsaturated monomer | Aldrich |
| (HPMA) | | |
| BYK-A 530 | Defoamer | BYK |
| Accelerator 553s | Cobalt octoate in solution | Nouryon |
| (accelerator) | (1.9% cobalt content) | |
| Tert-butyl | radical initiator | Nouryon |
| peroxylbenzoate | | |
| (TBPB) | | |
| ISOCYANATE | Mixture of monomeric and | Dow |
| A1-1 | polymeric MDI, NCO % = 32%, | |
| | visc@25C 50 mPa · s | |
| ISOCYANATE | Mixture of monomeric and | Dow |
| A1-2 | polymeric MDI, NCO % = 31%, | |
| | visc@25C 200 mPa · s | |
| Prepolymer A2 | As described in the “Synthesis | prepared in the |
| | of the prepolymers A2, A3- | “Synthesis |
| | 1 and A3-2” Section | of the prepolymers |
| | | A2, A3- |
| | | 1 and A3-2” Section |
| Prepolymer | As described in the “Synthesis | prepared in the |
| A3-1 | of the prepolymers A2, A3- | “Synthesis of the |
| | 1 and A3-2” Section | prepolymers A2, A3- |
| | | 1 and A3-2” Section |
| Prepolymer | As described in the “Synthesis | prepared in the |
| A3-2 | of the prepolymers A2, A3- | “Synthesis of the |
| | 1 and A3-2” Section | prepolymers A2, A3- |
| | | 1 and A3-2” Section |

Notes:
HPMA was further dried by adding molecular sieve beads; the other materials were used as received without any further purification. Radical initiators were kept in a refrigerator for storage and taken out of the refrigerator about 30 minutes before their use. All the major components were degassed under vacuum for 1 hour before castings.

Formulations and Test Results

Synthesis of the prepolymers A2, A3-1 and A3-2:

These prepolymers ware formed by reaction of isocyanate components with polyol components. The isocyanate components were added to a reactor and brought under stirring to 10 the reaction temperature (about 70 degreeC.), under nitrogen padding. The polyol components were premixed in case they consisted of more than one component, then added progressively into the reactor at a speed that is sufficiently low to allow removal of the exotherm generated by the reaction of the isocyanate groups with the hydroxyl groups. After completing the addition of the polyol components, the prepolymer was digested by beeping it under stirring at about 70 degreeC, while monitoring the NCO content according to ASTM D5155. The prepolymer formation was considered complete when the NCO reached the target NCO value. Further considerations applied as known by one of ordinary skill in the art of manufacturing prepolymers.

Prepolymer A2: it has an NCO content=23%. It was formed by the reaction of 4,4′-monomeric MDI (87 wt %) with tripropylene glycol (13 wt %)

Prepolymer A3-1: it has an NCO content=15%. It was formed by the reaction of isomeric mixture of 30%2,4′-MDI and 70%4,4′-MDI (18.1 wt %), and polymeric MDI with 32 wt % NCO content (31.8 wt %), with polypropylene glycol with EW=1002 g/eq (12.6), and with PO based triol with 15% EO cap and with EW=2040 g/eq (37.5).

Prepolymer A3-2: it has an NCO content=18.4%. It was formed by the reaction of 4,4′-monomeric MDI (65.5 wt %) with dipropylene glycol (4.1 wt %), EO capped PO based triol with about 15% EO cap and EW=2040 g/eq (10.3 wt %), and EO capped PO based diol with about 20% EO cap and EW-2025 g/eq (20.1 wt %).

Sample Preparation

All components were blended in the specified proportions in the order according to the table list, followed by thoroughly mixing using SpeedMixer (DAC 600. IFVZ, Hauschild) in a dynamic program (800 rpm for 10 s, 1200 rpm for 10 s, 1600 rpm for 10 s, 2000 rpm for 2 min). The obtained liquid resin was further degassed for 6 min under vacuum, and casted into a vertical steel mold and left in the oven at 40° C. for 1 hour, followed by 70°° C. overnight for complete curing. The casting plates were obtained by demolding on the next morning for cutting and testing.

### Inventive Example 1-3

Inventive Examples 1-3 were prepared according to the recipes shown in Table 2.

### Inventive Example 4-10

Inventive Examples 4-10 were prepared in the similar manner as described above. They differ from Example 1-3 in that prepolymers with different ratios or different final prepolymer wt % based on the total weight of the A) isocyanate component were used.

### Comparative Examples 1

Comparative Examples 1 used a lower HPMA amount compared to other Inventive Examples.

### Comparative Examples 2-3

Comparative Examples 2-3 are prepared according to prior art recipe using PMDI without specified prepolymers or combinations thereof.

### Comparative Examples 4-5

Comparative Examples 4-5 were formulations with individual prepolymer, at the same level of prepolymer wt % as Inventive Examples 7 and 9.

TABLE 2
Formulation details and key material properties for Inventive
Examples 1-3 and Comparative Example 1-3 with different HPMA %

| Components | IE 1 | IE 2 | IE 3 | CE 1 | CE 2 | CE 3 |
|---|---|---|---|---|---|---|
| Polyol | 11.2 | 14.6 | 17.9 | 38.1 | 12.7 | 19.0 |
| HPMA | 37.0 | 33.6 | 30.3 | 10.1 | 38.2 | 32.1 |
| BYK-A530 | 0.3 | 0.3 | 0.3 | 0.3 | 0.4 | 0.4 |
| Accelerator 553s | 0.02 | 0.02 | 0.0 | 0.0 | 0.0 | 0.0 |
| TBPB | 0.6 | 0.6 | 0.6 | 0.6 | 0.7 | 0.6 |
| Isocyanate A1-1 | 35.9 | 35.9 | 35.9 | 35.9 | 47.9 | 47.8 |
| Prepolymer A2 | 8.6 | 8.6 | 8.6 | 8.6 | — | — |
| Prepolymer A3-1 | 6.4 | 6.4 | 6.4 | 6.4 | — | — |
| Index | 103 | 103 | 103 | 103 | 103 | 103 |
| HPMA % | 37 | 33.6 | 30.3 | 10.1 | 38.2 | 32.1 |
| Polyol % | 11.2 | 14.6 | 17.9 | 38.1 | 12.7 | 19 |
| Prepolymer wt % | 30 | 30 | 30 | 30 | 0 | 0 |
| Open time (min) | 259 | 185 | 144 | 45 | — | 172 |
| Viscosity (mPa*s) | 32 | 45 | 52 | 155 | — | 34 |
| Flexural | 106 | 126 | 141 | 113 | 53 | 83 |
| strength/MPa | | | | | | |
| Strain at break % | 3.3 | 4.16 | 4.9 | 18.1 | 14 | 3.1 |
| Tg/° C. | 140 | 138 | 133 | 82 | 143 | 136 |
| HDT/° C. | 89 | 86 | 84 | 58 | 85 | 70 |

The Inventive Examples 1-3 and Comparative Example 1 show the performance of resin with different levels of HPMA %. With increasing amount of HPMA, open time increases, and initial viscosity of the uncured resin decreased accordingly. When the HPMA level is above 30%, resins with open time longer than 2 hours, together with good physical mechanical and thermal properties were obtained. When HPMA level was increased to 37% (Inventive Example 1), material strength showed a decrease compared with the other inventive examples in Table 2. When the HPMA level was 10% (Comparative Example 1), thermal stability does not meet the industrial standard. Results have demonstrated that for the current invention, the preferred HPMA monomer range is 25-40 wt %.

Instead, Comparative Example 2-3 which contains only polymeric isocyanate without prepolymers had shown significantly lower physical mechanical performance, compared to similar level of HPMA % (30-37%) as used in inventive examples, demonstrating the positive effect of prepolymer in physical mechanical properties. Due to this effect, the upper limit of usable HPMA in this process increased, therefore, resins with much longer open time can be obtained accordingly.

TABLE 3
Formulation details and key material properties for
Inventive Example 4-10 and Comparative Examples 4-5

| Components | IE 4 | IE 5 | IE 6 | IE 7 | IE 8 | IE 9 | IE 10 | CE 4 | CE 5 |
|---|---|---|---|---|---|---|---|---|---|
| Polyol | 15.2 | 17.4 | 18.3 | 17.5 | 17.1 | 16.3 | 16.3 | 17.8 | 15.7 |
| HPMA | 25.6 | 29.4 | 30.8 | 29.5 | 28.8 | 27.4 | 27.5 | 30.1 | 26.5 |
| BYK-A530 | 0.3 | 0.3 | 0.3 | 0.3 | 0.3 | 0.3 | 0.3 | 0.3 | 0.3 |
| Accelerator 553s | 0.02 | 0.02 | 0.02 | 0.02 | 0.02 | 0.02 | 0.02 | 0.02 | 0.02 |
| TBPB | 0.9 | 0.5 | 0.6 | 0.5 | 0.5 | 0.5 | 0.5 | 0.6 | 0.5 |
| Isocyanate A1-1 | 0.0 | 36.6 | 35.2 | 27.3 | 26.7 | 25.4 | 18.4 | 27.8 | 24.6 |
| Isocyanate A1-2 | 36.1 | | | | | | | | |
| Prepolymer A2 | | | 14.8 | 19.8 | 15.3 | 6.0 | 21.2 | 23.4 | |
| Prepolymer A3-1 | | 15.6 | | 4.9 | 11.3 | 24.1 | 15.7 | | 32.3 |
| Prepolymer A3-2 | 21.8 | | | | | | | | |
| Index | 102 | 103 | 103 | 103 | 103 | 103 | 103 | 103 | 103 |
| HPMA % | 25.6 | 29.4 | 30.8 | 29.5 | 28.8 | 27.4 | 27.5 | 30.1 | 26.5 |
| Polyol % | 15.2 | 17.4 | 18.3 | 17.5 | 17.1 | 16.3 | 16.3 | 17.8 | 15.7 |
| Prepolymer wt % of | 37% | 30% | 30% | 47% | 50% | 55% | 67% | 45% | 56% |
| total A | | | | | | | | | |
| (ratio of A2:A3) | | | | 4:1 | 1.4:1 | 1:4 | 1.4:1 | | |
| Open time (min) | 138 | 130 | 154 | 142 | 131 | 81 | 67 | 139 | 69 |
| Viscosity (mPa · s) | 89 | 90 | 44 | 62 | 71 | 126 | 127 | 49 | 149 |
| Flexural strength/MPa | 121 | 123 | 129 | 139 | 128 | 103 | 121 | 96 | 84 |
| Strain at break % | 5.3 | 6.98 | 3.71 | 4 | 5.03 | 6.2 | 5.5 | 2.5 | 8.1 |
| Tg/° C. | — | 143 | 128 | 117 | 126 | 125 | 126 | 115 | 132 |
| HDT/° C. | 89 | 82 | 81 | 77 | 79 | 70 | 77 | 76 | 63 |

When total prepolymer content at relatively low level (<45% as shown in Inventive examples 4,5,6), all three formulations containing individual prepolymer showed improved performance, compared to Comparative Example 3 which doesn't comprise any prepolymer. However, when prepolymer content was above a certain level, formulations with single prepolymer was hard to meet the performance criteria. As shown in Comparative Example 4, when only Prepolymer A2 (45% based on the total weight of the isocyanate component) was used, material became brittle leading to insufficient strength and strain % at break, on the other band, when only Prepolymer A3 (56%, based on the total weight of the isocyanate component) was used, insufficient strength will be obtained because of compromised stiffness

### (Comparative Example 5)

Surprisingly, when both prepolymers were combined at selected ratio (Inventive Example 7-10), all the formulations showed satisfying strength, with other desired properties well maintained. Prepolymer having NCO content <10% or higher >25% are out of scope. For a NCO content <10%, the prepolymers are extremely viscous (typically >4000 mPa·s at 25°° C.) and often contain large amount of long chain polyols, as a result, the liquid resin has an unfavored high initial viscosity, short open time and insufficient stiffness; when the NCO content >25%, the final cured resin suffers from poor mechanical strength and brittleness.

Inventive Examples 8 and 10 had shown the influence of prepolymer % (based on the total weight of the isocyanate component). The higher the prepolymer %, the less brittle the material is, but also having higher initial viscosity and shorter open time.

Open time and viscosity were measured with rheometer AntonPaar MCR 102, tests were carried out at 25° C., with 25 mm parallel plates, in rotational mode at shear rate 10 S-1. Open time is defined as the time needed from initial mixing until the mixture reaches 500 mPa·s.

Flexural test was performed according to the standard method ISO 178. Three-point bending mold was applied. Load cell: 1 kN, speed: 10 mm/min; For each sample 5 specimen with dimension 80×10×4 mm were measured.

Heat distortion temperature (HDT) was measured according to the standard method ISO 75-2-Mode A. Test was carried out with a DMA instrument with a three-point bending geometry. A static force was applied to the sample during heating from 35° C. to 150°° C. with ramp of 2° C./min. Displacement was measured in μm, and Temperature was recorded.

Glass transition temperature (Tg) was measured on a DMA instrument with a three-point bending geometry. The sample was heated from 40°° C. to 200°° C. with ramp of 3° C./min.

What is claimed is:

1. A polyurethane composition comprising
A) an isocyanate component comprising A1) and at least one of A2) or A3):
A1) a first polyisocyanate compound;
A2) a first prepolymer that is formed by reaction ofa second polyisocyanate compound and a first polyol, wherein the first polyol has an average equivalent weight of from 30 to 200 g/eq and an average functionality of 2-3 and the first prepolymer has a NCO content of 21-25% based on the weight of the first prepolymer;
A3) a second prepolymer that is formed by reaction of a third polyisocyanate compound and a second polyol, wherein the second polyol has an average equivalent weight of from 250 to 3000 g/eq and an average functionality of 2-3 and the second prepolymer has a NCO content of 10-20% based on the weight of the second prepolymer;
wherein the total amount of the first prepolymer A2) and the second prepolymer A3) is 10-70 wt %, based on the total weight of the isocyanate component A);
B) an isocyanate-reactive component comprising
B1) a third polyol; and
B2) an isocyanate reactive (meth)acrylate monomer; and
B) a free radical initiator.

2. The composition of claim 1, wherein the first prepolymer A2) and the second prepolymer A3) are used individually or in combination in any ratio, and wherein the total weight of the first prepolymer A2) and the second prepolymer A3) is less than 45 wt % based on the total weight of the isocyanate component A).

3. The composition of claim 1, wherein the total weight of the first prepolymer A2) and the second prepolymer A3) is from 45 wt % to 70 wt % based on the total weight of the isocyanate component A), and wherein the weight ratio of the first prepolymer A2) and the second prepolymer A3) is from 5:1 to 1:5.

4. The composition of claim 1, wherein the content of the polyisocyanate compound A1) is from 30 wt % to 90 wt % based on the total weight of the isocyanate component A).

5. The composition of claim 1, wherein the first prepolymer A2) has a NCO content of from 22 wt % to 24 wt % based on the weight of the first prepolymer A2).

6. The composition of claim 1, wherein the second prepolymer A3) has a NCO content of from 12 wt % to 19 wt % based on the total weight of the second prepolymer A3).

7. The composition of claim 1, wherein the total weight of the first prepolymer A2) and the second prepolymer A3) is from 45 wt % to 70 wt % based on the total weight of the isocyanate component A), and wherein the weight ratio of the first prepolymer and the second prepolymer is from 4:1 to 1:4.

8. The composition of claim 1, wherein the isocyanate reactive (meth)acrylate monomer B2) is selected from hydroxy C1-10 alkyl (meth)acrylate monomers.

9. The composition of claim 1, wherein the isocyanate reactive (meth)acrylate monomer B2) is selected from hydroxypropyl (meth)acrylate monomer and hydroxybutyl (meth)acrylate monomer.

10. The composition of claim 1, wherein the content of the isocyanate reactive (meth)acrylate monomer B2) is from 25 wt % to 40 wt % based on the total weight of the polyurethane composition.

11. The composition of claim 1, wherein the third polyol has an average functionality of 2 to 5 and an average equivalent weight of 80 to 600 g/eq.

12. The composition of claim 1, wherein the polyurethane composition further comprises other additives selected from the group consisting of catalysts for the reaction between the isocyanate group and the hydroxyl group, radical polymerization accelerators, defoamers, pigments, fillers, and moisture scavengers.

13. A composite material comprising a fiber reinforcement material and a polyurethane resin obtained from the polyurethane composition of claim 1.

14. A method of preparing a polyurethane resin using the polyurethane composition of claim 1:
1) providing a component A) an isocyanate component, comprising A1) and at least one of A2) and A3),
A1) a first polyisocyanate compound;
A2) a first prepolymer that is formed by reaction of a second polyisocyanate compound and a first polyol, wherein the first polyol has an average equivalent weight of from 30 to 200 g/eq and an average functionality of 2-3 and the first prepolymer has a NCO content of 21-25% based on the weight of the first prepolymer;
A3) a second prepolymer that is formed by reaction of a third polyisocyanate compound and a second polyol, wherein the second polyol has an average equivalent weight of from 250 to 3000 g/eq and an average functionality of 2-3 and the second prepolymer has a NCO content of 10-20% based on the weight of the second prepolymer;
wherein the total amount of the first prepolymer A2) and the second prepolymer A3) is 10-70 wt %, based on the total weight of the isocyanate component;
2) providing an isocyanate-reactive component B), comprising
B1) a third polyol; and
B2) an isocyanate reactive (meth)acrylate monomer; and
3 providing a free radical initiator C); and
4) then reacting the isocyanate component A) with the isocyanate-reactive component B) in the presence of the free radical initiator C) to form the polyurethane resin.
